(19) United States
(12) Patent Application Publication
(10) Pub. No.: US 2026/0218781 A1
(43) Pub. Date: Jul. 30, 2026

(54) Gearing, Drivetrain and Vehicle

(71) Applicant: ZF Friedrichshafen AG, Friedrichshafen (DE)

(72) Inventors: Kim Führer, Lindau (DE); Matthias Reisch, Ravensburg (DE); Patrick Klein, Langenargen (DE); Robert Lechner, Geldersheim (DE); David Jonak, Langenargen (DE); Matthias Winkel, Weingarten (DE); Christian Gürlich, Ravensburg (DE); Tamas Gyarmati, Bermatingen (DE)

(21) Appl. No.: 19/465,903

(22) Filed: Jan. 30, 2026

(30) Foreign Application Priority Data
Jan. 30, 2025 (DE) 102025103405.2

(51) Int. Cl. F16H 37/08; B60K 1/00; B60K 17/16; F16H 48/10; F16H 57/02; F16H 57/021

(52) U.S. Cl. CPC F16H 37/0813; B60K 1/00; B60K 17/165; F16H 48/10; F16H 57/021; B60K 2001/001; F16H 2048/104; F16H 2048/106; F16H 2057/02034; F16H 2057/02052

(57) ABSTRACT

A gearing for a vehicle includes a first planetary gear set and a second planetary gear set, each having a first element, a second element, and a third element. The second planetary gear set is mechanically operatively connected to the first planetary gear set. The gearing further includes a cylindrical gear for receiving a drive torque of a drive apparatus. The cylindrical gear is mechanically operatively connected to one element of the first planetary gear set or the second planetary gear set. The cylindrical gear overlaps in an axial direction with one of the elements of one of the first planetary gear set or the second planetary gear set.

### CROSS-REFERENCE TO RELATED APPLICATION

The present application is related and has right of priority to German Patent Application No. 10 2025 103 405.2 filed on Jan. 30, 2025, the entirety of which is incorporated by reference for all purposes.

### FIELD OF THE INVENTION

The present disclosure relates generally to a gearing for a vehicle. The disclosure also relates generally to a drivetrain including such a gearing and to a vehicle.

### BACKGROUND

Gearings for vehicles are known. In some cases, the gearing may include one or more gear sets for converting an input rotational speed into another, for example lower, output rotational speed. In some cases, the gearing may be arranged in a transverse direction of the vehicle between two driving elements, for example wheels, which are operatively connected to the gearing for driving the vehicle. In such cases, the available space for the gear sets between the driving elements may be limited in an axial direction of the gearing.

### SUMMARY OF THE INVENTION

The present disclosure relates in a first aspect to a gearing for a vehicle. Examples of the vehicle may include a passenger car, a truck, a bus, and a work machine. Examples of the work machine may include a tractor, a combine harvester, a municipal vehicle such as a road sweeper, an excavator, and a wheel loader. The vehicle may include a drive apparatus for directly or indirectly driving the vehicle by introducing power into the gearing. The gearing and the drive apparatus may form a drivetrain for driving the vehicle. The drive apparatus may include an internal combustion engine, a hydraulic motor, and/or an electric machine. The drive apparatus may receive energy from an energy storage device, for example a tank or a battery, and convert it into rotational mechanical energy, for example into a drive power for the gearing. The drive apparatus may further include apparatuses for converting electrical energy, for example a voltage converter and/or an inverter.

The gearing may include an input shaft and one or more output shafts. At least one output shaft of the gearing may be operatively connected to a drive element of the vehicle. The gearing may be configured to convert an input variable, for example a rotational speed and/or a torque, into an output variable of different magnitude. For example, the gearing may be configured to convert an input rotational speed into another, for example lower, output rotational speed depending on a transmission ratio. The gearing may alternatively, or additionally, be configured as a distribution gearing for distributing a power of the input shaft to the two output shafts. The gearing may also include a differential function. The drive element may be, for example, a wheel for contacting the ground or a drive wheel or sprocket for chains. The vehicle may include a shiftable gearing which is arranged in a power flow between the drive apparatus and the drive element.

If two elements are mechanically operatively connected, the elements are directly or indirectly coupled to one another such that a movement of one element causes a reaction of the other element. An operative connection may be produced, for example, by a frictional connection or a positive connection between the elements. The operative connection may correspond to an engagement between corresponding gearwheels of the two elements. Further elements, such as shafts, constant velocity joints, and/or one or more gear sets, may be present between the elements. If, on the other hand, two elements are permanently, non-rotatably connected to one another, these elements are rigidly coupled to one another for all intended states of the gearing such that they rotate at the same speed. Permanently, non-rotatably connected elements may be formed integrally, for example monolithically. They may also be non-rotatably connected to one another by a mechanical connection, for example a cohesive connection, such as by welding, or a screw connection. Two elements may be selectively, non-rotatably connectable to one another via a shift element. A shift element may be a frictional shift element, for example as a multi-disk clutch, or as a positive shift element, for example as a dog clutch. A positive shift element may also be configured to selectively non-rotatably engage or disengage splines with one another.

The gearing includes a first planetary gear set and a second planetary gear set. The first planetary gear set includes a first element, a second element, and a third element. The second planetary gear set includes a first element, a second element, and a third element. Examples of the elements of the planetary gear sets may include a sun gear, a planetary carrier, and a ring gear. Each of the planetary gear sets may include one or more planetary gears which are rotatably supported on the respective planetary carrier, for example via planetary pins. The planetary gears may mesh both with the sun gear and with the ring gear of the respective planetary gear set. The respective planetary gear set may be a plus planetary gear set or a minus planetary gear set. The first planetary gear set and the second planetary gear set may be configured identically or differently from each other. The second planetary gear set is mechanically operatively connected to the first planetary gear set. By the mechanical operative connection, power may be transmitted between the first planetary gear set and the second planetary gear set.

The gearing includes a cylindrical gear. The cylindrical gear is configured for receiving a drive torque of a drive apparatus. For example, the cylindrical gear may include a toothed portion (spur or helical) for meshing with a further element and for transmitting torque. The cylindrical gear may be part of a cylindrical gear stage. The cylindrical gear stage may include, in addition to the cylindrical gear, at least one further cylindrical gear which meshes with the cylindrical gear for transmitting torque. The cylindrical gear stage may be configured to provide a mechanical operative connection between the drive apparatus and the cylindrical gear. For example, the cylindrical gear stage may be configured for receiving a power of the drive apparatus and for transmitting the power to the cylindrical gear via the further cylindrical gear. The input shaft of the gearing may be mechanically operatively connected to the cylindrical gear stage, for example to the further cylindrical gear, and to the drive apparatus. In an example, the input shaft may be monolithically formed with a rotor shaft of the drive apparatus, for example of an electric machine, in order to receive power from the drive apparatus. In another example, the input shaft may be formed separately from the rotor shaft and coupled to the rotor shaft, for example permanently, non-rotatably connected.

The input shaft or rotor shaft and the planetary gear sets may be formed in an axially offset manner. The cylindrical gear stage may be configured to bridge the axial offset between the input shaft and the planetary gear sets. Optionally, the cylindrical gear stage may be configured to convert a drive rotational speed received by the input shaft into an output rotational speed applied to the cylindrical gear. In an example, the cylindrical gear stage may be configured as a pre-reduction stage in order to convert the drive rotational speed into a lower output rotational speed. In an example, the gearing may include a single cylindrical gear stage with exactly two cylindrical gears. In an example, the cylindrical gear stage may include more than two cylindrical gears. In an example, further elements, for example at least one of a clutch, a brake, an articulated shaft, or a chain drive, may be arranged in a power flow between the drive apparatus and the cylindrical gear.

The cylindrical gear is mechanically operatively connected to an element of the planetary gear sets. The one element of the planetary gear sets may be an element for introducing power into the planetary gear sets. The gearing may thus be configured to introduce power from the drive apparatus into the planetary gear sets via the input shaft and the cylindrical gear. In an example, the one element of the planetary gear sets may be the first element of the first planetary gear set. The cylindrical gear may be connected to a support portion. The support portion may be configured for rotatably supporting the cylindrical gear. The support portion may also be configured for supporting axial and/or radial forces from the cylindrical gear. Furthermore, the support portion may be configured for supporting tilting moments and bending moments of the cylindrical gear. The support portion may be configured to support the forces and torques received by the cylindrical gear on a stationary member, for example a housing. The support portion or parts thereof may be an axle without substantial transmission of torque. Alternatively, or additionally, the support portion or parts thereof may be a shaft for transmitting torque, for example between the cylindrical gear and the one element of the planetary gear sets. In an example, at least two of the first planetary gear set, the second planetary gear set, or the cylindrical gear may be arranged coaxially. In an example, both planetary gear sets, the cylindrical gear, the support portion, and two output shafts operatively connected to the planetary gear sets may be arranged coaxially to each other.

The cylindrical gear overlaps or aligns with one of the elements of the planetary gear sets in an axial direction. The axial direction may be an axial direction of a gear set of the gearing, for example of the first and/or the second planetary gear set. In an example, the axial direction may be aligned parallel to a transverse direction of the vehicle. The overlapped one of the elements of the planetary gear sets may be any one or more elements of the planetary gear sets. For example, the overlapped element of the planetary gear sets may be the one element operatively connected to the cylindrical gear. For example, the overlapped element may be at least one of a sun gear, a planetary carrier, a planetary pin, a planetary gear, or a ring gear. In an example, the above-described toothed portion of the cylindrical gear may overlap the one element of the planetary gear sets. The overlapped element of the planetary gear sets may be arranged partially or completely radially within the toothed portion of the cylindrical gear. The overlap may be a partial or complete overlap. The cylindrical gear may, for example, overlap one of the elements of the first planetary gear set in the axial direction, for example an element for introducing a torque into the first planetary gear set. The cylindrical gear may also overlap a plurality of elements of the planetary gear sets in the axial direction. In an example, all the elements of the first planetary gear set may be arranged in an axial plane, and the cylindrical gear may partially overlap all the elements of the first planetary gear set in the axial direction. In another example, the cylindrical gear may completely overlap all the elements of the first planetary gear set in the axial direction.

With the gearing according to the first aspect, the cylindrical gear, for example the toothed portion thereof, overlaps at least one of the elements of the planetary gear sets in the axial direction. Thereby, an installation space requirement in the axial direction is reduced in comparison with a configuration in which the cylindrical gear is arranged completely adjacent to the planetary gear sets in the axial direction. A gearing having a compact configuration in the axial direction is thus provided. Furthermore, the cylindrical gear enables the provision of a cylindrical gear stage which may provide an additional transmission ratio in a power flow between the drive apparatus and the drive elements. Thereby, a gearing having a high transmission ratio may be provided. For example, the overall transmission ratio of the gearing may be more than 5, in an example more than 10, in a further example more than 15 or more than 20. The high transmission ratio of the gearing enables, for example, the use of a small electric machine having a high rotational speed of the electric machine. The entire drivetrain of the vehicle thus becomes light, compact, cost-effective and sustainable. In summary, the gearing according to the first aspect achieves a high transmission ratio while at the same time having a compact configuration.

In an embodiment, the cylindrical gear is permanently, non-rotatably connected to the first element of the first planetary gear set for introducing a torque into the planetary gear sets. The permanently non-rotatable connection may optionally be configured to allow displacements in an axial direction. Alternatively, the non-rotatable connection may be permanent. In an example, the cylindrical gear may be welded to the one element of the planetary gear sets. In an example, the cylindrical gear may be formed monolithically with the one element of the planetary gear sets. In an example, the cylindrical gear may be non-rotatably connected to the one element of the planetary gear sets via a further member, which will be described further in the following.

In an embodiment, the first elements of the two planetary gear sets are each a sun gear, the second elements of the two planetary gear sets are each a planetary carrier, and the third elements of the two planetary gear sets are each a ring gear. In an alternative embodiment, the third element of the first planetary gear set and the first element of the second planetary gear set are each a sun gear, the second elements of the two planetary gear sets are each a planetary carrier, and the first element of the first planetary gear set and the third element of the second planetary gear set are each a ring gear. Both of the aforementioned embodiments provide a simple and cost-effective interconnection of the planetary gear sets of the gearing. In both embodiments, the first and the second planetary gear sets may each be a minus planetary gear set.

In an embodiment, the third element of the first planetary gear set is permanently, non-rotatably connected to the first element of the second planetary gear set. In case the third element of the first planetary gear set is a ring gear and the first element of the second planetary gear set is a sun gear, a gearing thus interconnected includes a ring gear to sun gear coupling of the two planetary gear sets. In case the third element of the first planetary gear set and the first element of the second planetary gear set are each a sun gear, a gearing thus interconnected includes a sun gear to sun gear coupling of the two planetary gear sets. In both cases, the non-rotatable connection may be provided as described above. In an example, the third element of the first planetary gear set and the first element of the second planetary gear set may be permanently, non-rotatably connected via a coupling element.

The coupling element may be configured for transmitting torque between the third element of the first planetary gear set and the first element of the second planetary gear set. The coupling element may be non-rotatably connected to the respective element of the respective planetary gear set. The non-rotatable connection to the two elements, namely the third element of the first planetary gear set and the first element of the second planetary gear set, may be effected in the same manner or differently. In an example, the coupling element may be connected to at least one of the two elements via a spline. The spline may be configured to transmit a torque and optionally enable axial and/or radial compensating movements. For example, the coupling element may be provided with an additional axial securing means, for example by a support ring or snap ring. Alternatively, or additionally, the coupling element may be permanently, non-rotatably connected to at least one of the two elements by being formed monolithically. In one configuration, the coupling element may be non-rotatably connected to the third element of the first planetary gear set via a spline. In an alternative configuration, the coupling element may be formed monolithically with the third element of the first planetary gear set. In one configuration, the coupling element may be welded to the first element of the second planetary gear set. In one configuration, the coupling element may be welded to both of the two elements.

In an embodiment, the first planetary gear set and the second planetary gear set are arranged axially offset to each other. Thereby, a compact configuration in a radial direction of the planetary gear sets is achieved. If a coupling element as described above is provided, it may be arranged between the planetary gear sets in the axial direction. The coupling element may extend at least partially in the radial direction. In the present embodiment, the tooth engagement of the innermost element of the first planetary gear set is optionally arranged radially outside the tooth engagement of the innermost element of the second planetary gear set. The respective innermost elements may, for example, be sun gears of the respective planetary gear set. Thereby, a radial dimension of the second planetary gear set may be small. In an alternative embodiment, the first planetary gear set and the second planetary gear set overlap at least partially in the axial direction such that one of the planetary gear sets is arranged at least partially radially outside the other of the planetary gear sets.

In an embodiment, the second element of the second planetary gear set is non-rotatably fixed or non-rotatably fixable to a stationary member. A first output shaft may be permanently, non-rotatably connected to the second element of the first planetary gear set. A second output shaft may be permanently, non-rotatably connected to the third element of the second planetary gear set. Thereby, a torque distribution gearing for distributing an input power to the two output shafts is provided having a simple configuration. Each output shaft may, for example, be operatively connected to a respective drive element such that the power for driving the vehicle is distributed. If the second element of the second planetary gear set is selectively non-rotatably connectable to the stationary member, the gearing may provide a so-called disconnect functionality in which the planetary gear sets have no housing support and thus the drive apparatus can rotate freely. Thus, for example, drag torques may be reduced and/or a rotational speed synchronization may be enabled.

In an embodiment, the first output shaft and at least parts of the second element of the first planetary gear set are formed monolithically. This enables a particularly compact, light and cost-effective configuration of the gearing. In an example, a part of the second element of the first planetary gear set, for example a part of a planetary carrier, may be manufactured from the same blank, for example forged blank, as the first output shaft. Further parts of the second element of the first planetary gear set may be attached to a part of the second element manufactured in this way, for example by welding.

In an embodiment, the gearing, with the exception of the planetary gear sets, is configured such that planetary gear sets interconnected for a ring gear to sun gear coupling or planetary gear sets interconnected for a sun gear to sun gear coupling are selectively installable. As a result, identical parts may be used, depending on requirements, both for interconnection with a ring gear to sun gear coupling and for interconnection with a sun gear to sun gear coupling. For example, at least some of a housing, one or more shafts, such as the output shafts, and one or more shaft bearings may be usable as identical parts independently of the interconnection of the gearing. Elements of the planetary gear sets may also be configured such that they are usable for both interconnections. Examples of such elements may include planetary carriers, planetary bearings, planetary gears, and planetary pins. Depending on the configuration, it may consequently be sufficient to exchange only the cylindrical gear, possibly the support portion, the first element of the first planetary gear set and the combination of the third element of the first planetary gear set, the first element of the second planetary gear set and possibly the coupling element, in order to change between a sun gear to sun gear coupling and a ring gear to sun gear coupling. As a result, the manufacture of different gearing variants may be cost-effective. Furthermore, retrofitting of an existing gearing is enabled.

In an embodiment, the gearing includes a support portion mechanically operatively connected to the cylindrical gear. The support portion may be configured as described above. The mechanical operative connection may be configured for absorbing tilting moments and/or bending moments of the cylindrical gear. The cylindrical gear and the support portion may be rigidly coupled, for example provided monolithically or welded to one another. The gearing may further include a bearing for rotatably supporting the support portion in a housing portion and for absorbing bending moments of the cylindrical gear. The housing portion may be part of a housing.

The housing may be provided as one or more housing portions for enclosing stationary and/or rotational components of the gearing and/or the drive apparatus. The housing may also be a stationary member for supporting and receiving forces and torques. The housing may include a plurality of housing portions. Each housing portion may be configured to receive and support different components. For example, the housing may include one or more gearing housing portions for enclosing and rotatably supporting parts of the gearing, for example one or more planetary gear sets. For example, the housing may include one or more drive apparatus housing portions for enclosing and rotatably supporting parts of the drive apparatus, for example of an electric machine. In an example, the support portion may be supported in the drive apparatus housing portion in order to support bending moments of the cylindrical gear via the bearing on the drive apparatus housing portion. The exemplary housing portions may be mounted to each other or at least partially formed monolithically.

In an embodiment, the gearing includes a further bearing for increasing the absorption capacity of bending moments of the cylindrical gear. The further bearing may be provided in addition to the above-described bearing for supporting the support portion. The further bearing may be configured to counteract tilting of the support portion with respect to the bearing due to bending moments of the cylindrical gear. The further bearing may be spaced apart from the bearing in an axial direction of the support portion. In an example, the bearing and the further bearing may be arranged on the same axial side of the cylindrical gear. By providing the further bearing in addition to the bearing, greater bending moments of the cylindrical gear can be supported. This is advantageous in particular when large axial, radial, and/or tangential forces act on the toothing of the cylindrical gear, for example in the case of a helical toothing of the cylindrical gear.

In an embodiment, at least one of the bearing or the further bearing is arranged on an axial side of the cylindrical gear facing away from the planetary gear sets. Thereby, the cylindrical gear may be arranged close to the planetary gear sets and may overlap the one overlapped element of the planetary gear sets to a higher degree with a simple configuration. In an example, both bearings are arranged on the axial side of the cylindrical gear facing away from the planetary gear sets.

In an embodiment, the first output shaft and the support portion are supported in the same housing portion. Thereby, the configuration of the housing is simplified, since only one housing portion having sufficient stiffness for receiving the forces of the first output shaft and the support portion needs to be provided. In an embodiment, the housing portion is configured for receiving and supporting an electric machine. Since the electric machine, for example a stator of the electric machine, may increase the stiffness of the housing portion receiving it, this housing portion is particularly suitable for supporting the first output shaft and/or the support portion.

In an embodiment, the gearing includes a coupling element for transmitting torque between the third element of the first planetary gear set and the first element of the second planetary gear set. The coupling element may be configured as described above. The coupling element may include at least one support element for supporting axial forces on at least one of the first planetary gear set and the second planetary gear set. For example, the support element may be a thrust element or a pressure comb. The thrust element may optionally be provided with a clearance fit. The support element may be configured to support axial forces of the coupling element on one or both planetary gear sets. For example, the support element may be configured to support axial forces in one or both axial directions on a planetary gear of a planetary gear set. In an example, the gearing may be configured such that axial forces of the coupling element in one axial direction are supported on the first planetary gear set via a support element, and axial forces of the coupling element in the other axial direction are supported on the second planetary gear set via a further support element. Alternatively, or additionally, the coupling element and/or an element connected thereto, for example an element being a sun gear or a ring gear, may be configured to support forces on an element being a planetary carrier. The support may be effected, for example, as a sliding bearing or as a rolling bearing.

In an embodiment, the cylindrical gear and the one planetary gear set element that is mechanically operatively connected thereto each mesh via a helical toothing with a respective further element. For example, the cylindrical gear may mesh with the above-described further cylindrical gear and the element that is mechanically operatively connected thereto, for example the first element of the first planetary gear set, may mesh with a further element, for example an element connected to the second element of the first planetary gear set. The one further element may be configured, for example, as a planetary gear. The helical toothings may be configured such that the axial forces thereof at least partially compensate each other. This may be effected, for example, via the selection of the helix angles of the toothings. In an example, helix angles are selected, taking into account the ratios of the tangential forces and the diameters, such that the resulting axial forces compensate each other only partially, for example with a degree of compensation of more than 50%, for example 80% or more. In a further example, the resulting axial forces compensate each other completely, for example with a degree of compensation of 95% or more. With regard to the first element of the first planetary gear set, the above-described compensation of the axial forces may be used both for a sun gear and for a ring gear.

In an embodiment, the third element of the first planetary gear set and the first element of the second planetary gear set each mesh via a helical toothing with a respective further element. For example, the third element of the first planetary gear set and the first element of the second planetary gear set may each mesh with one or more planetary gears. The helical toothings, for example the helix angles thereof, may be configured such that the axial forces thereof at least partially compensate each other. The above-described applies to the degrees of compensation of the partial or complete compensation.

In an embodiment, helical directions of the respective helical toothings are configured such that a lubricant conveying action is effected in the helical toothings for promoting a lubricant discharge in order to reduce drag torques. Accordingly, it is made possible that the lubricant may flow away and does not have to be dragged by the gearing and the toothings. The lubricant may include an oil, for example. In an example, the helical directions may be configured such that a conveying action is effected in the helical toothing for conveying and discharging the lubricant from the helical toothing in the direction of the first output shaft.

In an embodiment, an element of one of the planetary gear sets formed as a sun gear includes an inner circumferential surface which guides lubricant towards the other planetary gear set. In an example, the first element of the second planetary gear set may include the inner circumferential surface. The inner circumferential surface of the one planetary gear set may be conical, for example, for guiding lubricant towards the other planetary gear set. Alternatively, or additionally, the inner circumferential surface may be configured with a radial boundary on the side of the inner circumferential surface opposite to the other planetary gear set. Due to the configuration of the inner circumferential surface, the lubricant may be conveyed along the inner circumferential surface. The lubricant may also flow away from an end of the inner circumferential surface facing the other planetary gear set to the other planetary gear set in order to be supplied to the other planetary gear set. For example, the lubricant may be ejected at the end of the inner circumferential surface due to a rotation of the one element formed as a sun gear. As a further example, due to gravity, the lubricant may flow away from the end of the inner circumferential surface through the inner circumferential surface when the one of the planetary gear sets is stationary. The lubricant supplied from the inner circumferential surface to the other planetary gear set may be used directly or indirectly for lubricating the other planetary gear set. For example, the supplied lubricant may be at least partially captured by a lubricant capturing component and supplied to elements of the other planetary gear set, for example a planetary pin, a planetary gear and/or a planetary bearing.

In an embodiment, an element of the first planetary gear set formed as a ring gear is coupled to the cylindrical gear or to the first element of the second planetary gear set via a carrier plate for transmitting torque. In an example with a ring gear to sun gear coupling, the carrier plate may couple the third element of the first planetary gear set as a ring gear to the first element of the second planetary gear set as a sun gear for transmitting torque. In such an example, the above-described coupling element may be a carrier plate. In an example with a sun gear to sun gear coupling, the carrier plate may couple the first element of the first planetary gear set formed as a ring gear to the cylindrical gear for transmitting torque. In both cases, the carrier plate may be a thin-walled, at least partially radially extending member. The carrier plate may be configured to non-rotatably connect the two elements which it couples. The carrier plate may be non-rotatably connected to at least one of the two elements which it couples, for example via a spline. The spline may be configured to transmit a torque and optionally enable axial and/or radial compensating movements. The carrier plate may be provided with an additional axial securing means, for example by a support ring or snap ring. Alternatively, or additionally, one of the elements, for example the element formed as a ring gear, may be secured axially relative to the carrier plate by deforming the carrier plate. Alternatively, or additionally, the carrier plate may be permanently, non-rotatably connected to at least one of the two elements, for example by being welded or formed monolithically.

In a second aspect, the present disclosure relates to a drivetrain. The drivetrain may for example form a drive axle of the vehicle, for example a front axle or a rear axle. The drivetrain includes a gearing according to the first aspect. The drivetrain further includes a drive apparatus, for example including an electric machine, for providing a drive torque. The electric machine may include a rotor and a rotor shaft which is coupled to the rotor for transmitting torque. The respective advantages and further features may be taken from the description of the first aspect, wherein embodiments of the first aspect also form embodiments of the second aspect and vice versa.

In an embodiment, the drive apparatus, for example the electric machine, is arranged axially parallel and spaced apart from the planetary gear sets and the output shafts. Thereby, a radial installation space on one side of the output shafts, for example on a front or rear side, may be used for accommodating the drive apparatus such that an installation space remains free on other sides of the output shafts, for example on an upper and/or lower side. This is particularly advantageous when the drivetrain is used in a vehicle in which the ground clearance below the vehicle is restricted and/or the installation space above the output shafts is to be usable for a cargo space. The drive apparatus, for example the rotor shaft of the electric motor, may be mechanically operatively connected to the one element of the planetary gear set via the cylindrical gear. For example, the cylindrical gear may be part of the above-described cylindrical gear stage. Thereby, a transmission ratio of the drivetrain between the electric machine and the output shafts may be large.

In an embodiment, the drive apparatus includes an electric machine with a rotor and a stator, wherein the stator and the rotor do not overlap the planetary gear sets in the axial direction. In this case, the electric machine, for example the stator and/or the rotor, may at least partially overlap the planetary gear sets in the radial direction. Thus, a radial installation space requirement of the drivetrain may be low.

In an embodiment, the first planetary gear set is arranged in the axial direction between the second planetary gear set and the drive apparatus. This enables a particularly compact configuration. In an embodiment, the cylindrical gear is arranged in the axial direction between the first planetary gear set and the drive apparatus. This also enables a particularly compact configuration. In case a support portion is provided for the cylindrical gear and the drive apparatus includes an electric machine, the support portion may at least partially overlap at least one of the stator and the rotor of the electric machine in the axial direction.

In an embodiment, a further cylindrical gear is non-rotatably connected to the rotor shaft via a spline. For example, the further cylindrical gear together with the cylindrical gear may form the above-described cylindrical gear stage or be a part thereof. The further cylindrical gear may be removably attached to a rotor shaft of the drive apparatus via the spline. In case the input shaft is formed separately from the rotor shaft and non-rotatably connected thereto, the further cylindrical gear may be removably attached to the input shaft and non-rotatably connected thereto. The rotor shaft may be supported in a stationary member, for example a housing portion, via one or more rotor shaft bearings. A rotor shaft bearing may be arranged axially between the further cylindrical gear and a rotor of the drive apparatus. An inner diameter of the further cylindrical gear may be smaller than an inner diameter of this rotor shaft bearing. The further cylindrical gear may be supported via the input shaft and/or the rotor shaft. Alternatively, or additionally, the further cylindrical gear may be supported via a cylindrical gear bearing. The cylindrical gear bearing may, for example, be arranged on a side of the further cylindrical gear facing away from the rotor shaft. By the present embodiment, a simple assembly and support of the rotor shaft, the input shaft and the further cylindrical gear is achieved.

In a third aspect, the present disclosure relates to a vehicle. The vehicle includes a gearing according to the first aspect or a drivetrain according to the second aspect. The respective advantages and further features can be taken from the description of the first or second aspect, wherein embodiments of the first or second aspect also form embodiments of the third aspect and vice versa.

### BRIEF DESCRIPTION OF THE DRAWINGS

FIG. 1 shows a vehicle including a gearing according to an embodiment of the present disclosure.

FIG. 2 schematically shows a general interconnection of a gearing for the vehicle of FIG. 1 according to an embodiment of the present disclosure.

FIG. 3 schematically shows a drivetrain including a gearing in accordance with the interconnection of FIG. 2 according to an embodiment of the present disclosure.

FIG. 4 schematically shows a drivetrain including a gearing in accordance with the interconnection of FIG. 2 according to an embodiment of the present disclosure.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

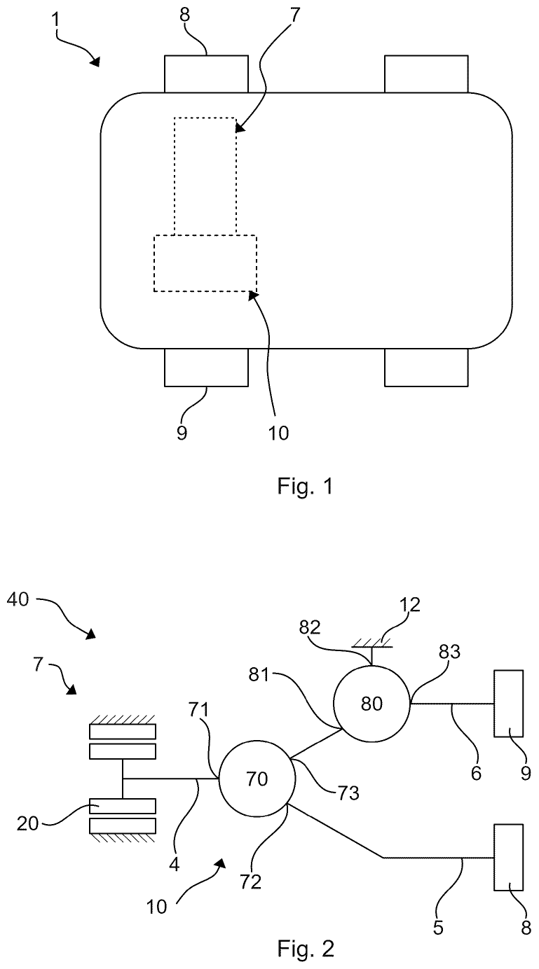

FIG. 1 shows a vehicle 1 including a gearing 10 according to an embodiment of the present disclosure. The vehicle 1 includes a drive apparatus 7. The gearing 10 is configured to transmit power, which is introduced by the drive apparatus 7, to at least two drive elements 8, 9, which in the present case are wheels.

FIG. 2 schematically shows a general interconnection of the gearing 10 according to an embodiment of the present disclosure. In the present embodiment, the gearing 10 is formed as a torque distribution gearing including two planetary gear sets. As can be seen from FIG. 2, the gearing 10 includes a first planetary gear set 70 with a first element 71, a second element 72, and a third element 73. Furthermore, the gearing 10 includes a second planetary gear set 80 with a first element 81, a second element 82, and a third element 83. The drive apparatus 7 and the gearing 10 form a drivetrain 40 for driving the vehicle 1. Power, which is generated by an electric machine 20 of the drive apparatus 7, may be introduced into the gearing 10 via an input shaft 4. The input shaft 4 is mechanically operatively connected to the first element 71 of the first planetary gear set 70, in the present case via a pre-reduction stage (not shown). The third element 73 of the first planetary gear set 70 is permanently, non-rotatably connected to the first element 81 of the second planetary gear set 80. The second element 82 of the second planetary gear set 80 is permanently, non-rotatably fixed or non-rotatably connectable to a stationary member 12, the stationary member 12 being a housing portion for receiving and supporting the second planetary gear set 80. A first output shaft 5 is mechanically operatively connected to the second element 72 of the first planetary gear set 70, in this case permanently, non-rotatably connected, in order to output power to a first drive element 8. A second output shaft 6 is mechanically operatively connected to the third element 83 of the second planetary gear set 80, in this case permanently, non-rotatably connected, in order to output power to a second drive element 9.

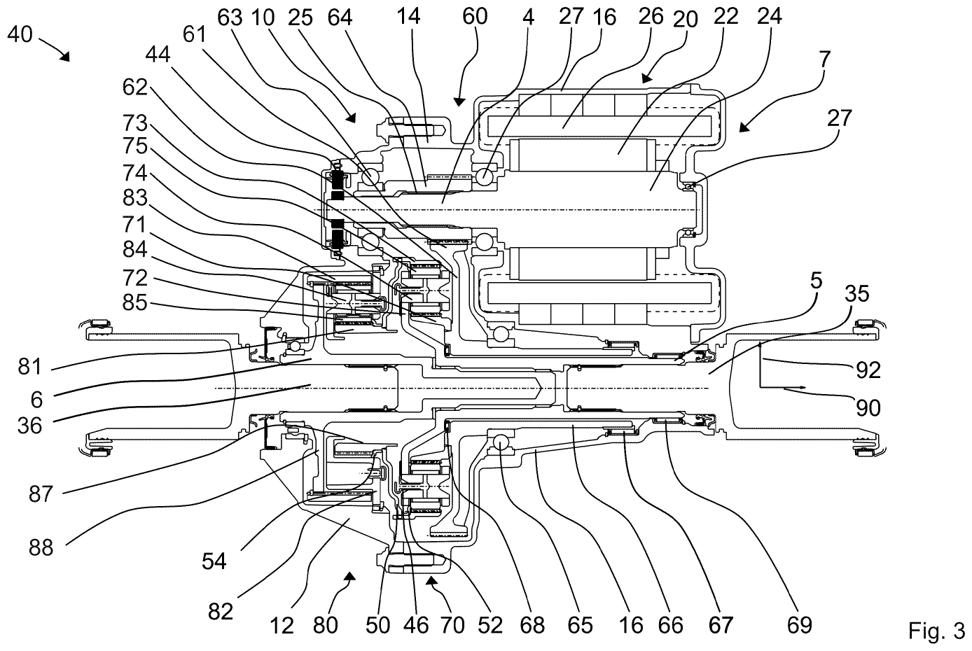

FIG. 3 shows a drivetrain 40 including a gearing 10 according to an embodiment of the present disclosure. The gearing 10 of the present embodiment is provided in accordance with the interconnection shown in FIG. 2. The gearing 10 is presently part of the drivetrain 40, which also includes a drive apparatus 7 including an electric machine 20. In the present embodiment, each of the first elements 71, 81 is a sun gear, each of the second elements 72, 82 is a planetary carrier, and each of the third elements 73, 83 is a ring gear. A plurality of planetary pins 74, 84, on which respective planetary gears 75, 85 are rotatably supported, are fixed to each planetary carrier 72, 82. Furthermore, the first planetary gear set 70 and the second planetary gear set 80 are arranged offset to each other along an axial direction 90. The first output shaft 5 is permanently, non-rotatably connected to the planetary carrier 72 of the first planetary gear set 70. In the present embodiment, the first output shaft 5 and the planetary carrier 72 of the first planetary gear set 70 are formed monolithically from a common forged blank. In the present case, the second output shaft 6 is permanently, non-rotatably connected to the ring gear 83 of the second planetary gear set 80 via a coupling portion 88. In the present case, the output shafts 5, 6 and the planetary gear sets 70, 80 are arranged coaxially to each other. In addition, the respective output shaft 5, 6 is presently non-rotatably connected to the respective drive element 8, 9 (not shown) via a respective stub shaft 35, 36.

The third element 73, formed in the present case as a ring gear, of the first planetary gear set 70 is permanently, non-rotatably connected via a coupling element 50 to the first element 81, formed in the present case as a sun gear, of the second planetary gear set 80. In the present case, the coupling element 50 is non-rotatably connected to the ring gear 73 of the first planetary gear set 70 via an axially and radially movable spline for transmitting torque. The axial movability is presently only present during assembly and is at least substantially prevented in the assembled state by a retaining ring. The radial movability is presently substantially limited to the fact that the ring gear 73 of the first planetary gear set 70 may yield radially locally within the scope of a polygonization which the planetary gears 75 can generate under load. In addition, the coupling element 50 is presently welded to the sun gear 81 of the second planetary gear set 80. The coupling element 50 is presently a carrier plate and extends inwardly in a radial direction 92 from the ring gear 73 of the first planetary gear set 70 to the sun gear 81 of the second planetary gear set 80. For axial support, respectively optional support elements 52, 54 are provided on both axial sides of the coupling element 50. In the present case, the support elements 52, 54 are each a pressure comb. A first support element 52 is arranged on the axial side of the coupling element 50 facing the first planetary gear set 70, namely the right-hand side in FIG. 3. The first support element 52 is configured to support axial forces in the direction of the first planetary gear set 70 on the planetary gears 75 of the first planetary gear set 70. A second support element 54 is arranged on the axial side of the coupling element 50 facing the second planetary gear set 80, namely the left-hand side in FIG. 3. The second support element 54 is configured to support axial forces in the direction of the second planetary gear set 80 on the planetary gears 85 of the second planetary gear set 80.

The input shaft 4 of the gearing 10 is presently formed monolithically with a rotor shaft 24 of the electric machine 20 of the drive apparatus 7. The rotor shaft 24 is coupled, presently permanently, non-rotatably connected, to a rotor 22 of the electric machine 20 for transmitting torque. The electric machine 20 also includes a stator 26 which is fixed to a housing portion 16. The housing portion 16 is configured to receive and support the electric machine 20. The housing portion 16, together with a first planetary gear set housing portion 14, which is configured for receiving and supporting the first planetary gear set 70, and a second planetary gear set housing portion 12, which is configured for receiving and supporting the second planetary gear set 80, forms a housing of the drivetrain 40. In some instances, the first planetary gear set housing portion 14 and the housing portion 16 are presently formed monolithically as a single housing member. The rotor shaft 24 is rotatably supported in the housing portion 16, in the present case via two rotor shaft bearings 27. Presently, a rotor position and/or rotational speed sensor 44 is provided at an axial end of the rotor shaft 24 or of the input shaft 4, namely the left-hand end in FIG. 3.

The input shaft 4 is mechanically operatively connected to the first element 71 of the first planetary gear set 70 via a cylindrical gear stage 60. In the present case, the cylindrical gear stage 60 is a pre-reduction stage in a power flow from the input shaft 4 to the first element 71 of the first planetary gear set 70. In the present case, the cylindrical gear stage 60 includes a cylindrical gear 62 and a further cylindrical gear 64. The cylindrical gear 62 meshes with the further cylindrical gear 64 for transmitting torque. The cylindrical gear 62 is non-rotatably connected to the first element 71 of the first planetary gear set 70, in the present case by welding, in order to introduce power into the first planetary gear set 70. In addition, the cylindrical gear 62 presently partially overlaps the first element 71 of the first planetary gear set 70 in the axial direction 90. More specifically, a toothed portion 61 of the cylindrical gear 62 presently overlaps the first element 71 of the first planetary gear set 70. Since, in the present embodiment, the sun gear 71, the planetary gears 75, and the ring gear 73 of the first planetary gear set 70 are arranged in one axial plane, the cylindrical gear 62 presently overlaps all elements of the first planetary gear set 70 in the axial direction 90. Furthermore, the toothed portion 61 of the cylindrical gear 62 is arranged radially outside the radially outermost element of the first planetary gear set 70, namely the ring gear 73.

The cylindrical gear 62 is presently formed monolithically with a support portion 66. The cylindrical gear 62 extends radially outwardly in a disk shape from the support portion 66 and includes the axially wider toothed portion 61 on a radially outer side. The toothed portion 61 overlaps the elements 71, 72, 73 of the first planetary gear set 70 and provides a toothing for meshing with the further cylindrical gear 64. The support portion 66 is presently configured to support bending moments of the cylindrical gear 62 on the housing portion 16 via a support bearing 65 and a further bearing 67. Furthermore, the first output shaft 5 is supported via an axial bearing 68 on the support portion 66 and via a radial bearing 69 on the housing portion 16. The further cylindrical gear 64 is permanently, non-rotatably connected to the input shaft 4 and the rotor shaft 24, presently via a spline 25. In addition, the further cylindrical gear 64 is supported via a cylindrical gear bearing 63 as a fixed bearing in the housing, presently in the first planetary gear set housing portion 12, in order to support its reaction forces.

In the present embodiment, the toothings between the elements of the planetary gear sets 70, 80 and the toothing of the cylindrical gear stage 60 are each formed as helical toothings. With respect to the coupling element 50, the helical toothings of the third element 73 of the first planetary gear set 70 and of the first element 81 of the second planetary gear set 80, more specifically the helix angles of these toothings, are configured such that the axial forces thereof at least partially compensate each other. In addition, the helical directions of the respective toothings are configured such that a lubricant conveying action is effected therein which promotes a lubricant discharge from the respective toothing. As a result, drag torques of the gearing 10 lubricated with a lubricant, in the present case oil, may be reduced. In order to promote the lubricant supply of the first planetary gear set 70, an inner circumferential surface 87 of the sun gear 81 of the second planetary gear set 80 is configured to be conical in the present embodiment. As a result, lubricant may flow along the conically formed inner circumferential surface 87 during rotation of the sun gear 81 of the second planetary gear set 80. At an axial end of the inner circumferential surface 87, the lubricant may be ejected and captured by a lubricant capturing component 46 which is attached to the planetary pin 74 of the first planetary gear set 70 and supplied to the first planetary gear set 70 via the planetary pin 74.

With the gearing 10 of the present embodiment of FIG. 3, an axially and radially compact gearing having a very high transmission ratio is provided.

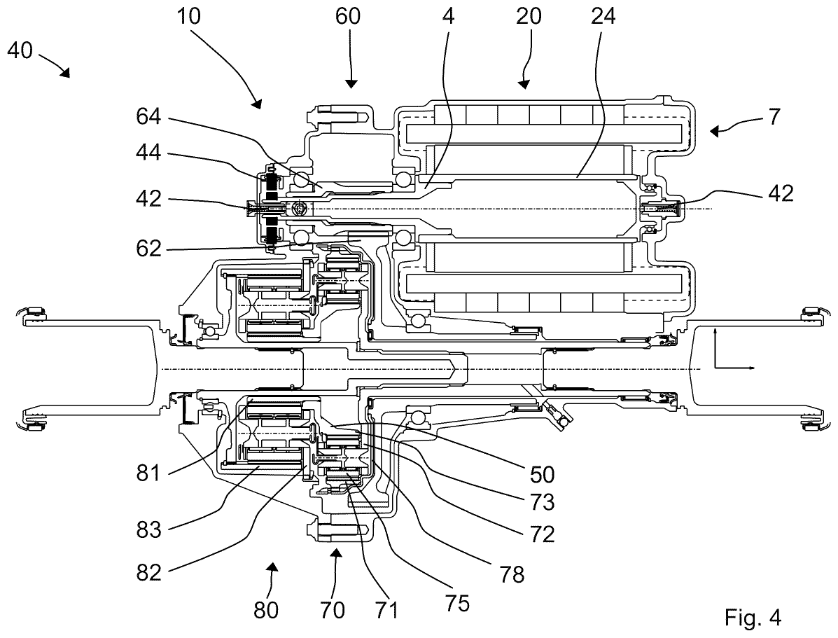

FIG. 4 shows a drivetrain 40 including a gearing 10 according to an embodiment of the present disclosure. The drivetrain 40 of FIG. 4 is configured identically to the drivetrain 40 of FIG. 3 with the exception of the following differences. While the gearing 10 of FIG. 3 includes an interconnection with a ring gear to sun gear coupling, the gearing 10 of FIG. 4 includes an interconnection with a sun gear to sun gear coupling. Accordingly, in FIG. 4, the third element 73 of the first planetary gear set 70 is presently a sun gear, and the first element 71 of the first planetary gear set 70 is presently a ring gear. The sun gear 73 of the first planetary gear set 70 is formed monolithically with the coupling element 50. The coupling element 50 is presently welded to the sun gear 81 of the second planetary gear set 80. Furthermore, in the present embodiment, a carrier plate 78 is provided for non-rotatably connecting the cylindrical gear 62 to the first element 71 of the first planetary gear set 70 a ring gear. The carrier plate 78 is presently a thin-walled member which extends substantially radially. The carrier plate 78 is welded to the support portion 66 on its radially inner circumferential edge. The carrier plate 78 includes a spline on a radially outer circumferential edge for transmitting torque to the ring gear 71 of the first planetary gear set 70, which spline is presently incorporated directly in the carrier plate 78. The carrier plate 78 is also presently subjected to a deformation process on its radially outer circumferential edge in order to axially secure the ring gear 71.

Furthermore, the rotor shaft 24 in the present embodiment of FIG. 4 is a hollow shaft. Furthermore, the input shaft 4 in the present case is formed separately from the rotor shaft 24 and joined thereto, in the present case by being pressed. In addition, the toothing of the cylindrical gear stage 60 is incorporated directly into an outer circumferential surface of the further cylindrical gear 64, presently by milling. Shaft grounding devices 42 are respectively provided on an end face of the rotor shaft 24, namely the right-hand side in FIG. 4, and on an end face of the input shaft 4, namely the left-hand side in FIG. 4. Presently, one of the shaft grounding devices 42, namely that of the input shaft 4, is arranged radially within the rotor position and/or rotational speed sensor 44.

The gearing 10 of the present embodiment of FIG. 4 achieves the same advantages as the gearing 10 of the embodiment of FIG. 3. Furthermore, a higher efficiency may be achieved by the sun gear to sun gear coupling of FIG. 4 than by the ring gear to sun gear coupling of FIG. 3.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE SIGNS

1 vehicle
4 input shaft
5, 6 output shaft
7 drive apparatus
8, 9 drive element
10 gearing
12, 14, 16 housing portion
20 electric machine
22 rotor
24 rotor shaft
25 spline
26 stator
27 rotor shaft bearing
35, 36 stub shaft
40 drivetrain
42 shaft grounding device
44 rotor position and/or rotational speed sensor
46 lubricant capturing component
50 coupling element
52, 54 support element
60 cylindrical gear stage
61 toothed portion
62, 64 cylindrical gear
63, 65, 67, 68, 69 bearing
66 support portion
70, 80 planetary gear set
71, 81 first element
72, 82 second element
73, 83 third element
74, 84 planetary pin
75, 85 planetary gear
78 carrier plate
87 inner circumferential surface
88 coupling portion
90 axial direction

1-27. canceled

28. A gearing (10) for a vehicle (1), comprising:
a first planetary gear set (70) with a first element (71), a second element (72), and a third element (73);
a second planetary gear set (80) with a first element (81), a second element (82), and a third element (83), the second planetary gear set (80) being mechanically operatively connected to the first planetary gear set (70); and
a cylindrical gear (62) for receiving a drive torque of a drive apparatus (7), the cylindrical gear (62) being mechanically operatively connected to one element (71) of the first element, the second element, or the third element of the first planetary gear set (70) or the second planetary gear set (80), the cylindrical gear (62) overlapping in an axial direction (90) with one of the first element (71), the second element (72), or the third element (73) of one of the first planetary gear set (70) or the second planetary gear set (80).

29. The gearing (10) of claim 28, wherein the cylindrical gear (62) is permanently, non-rotatably connected to the first element (71) of the first planetary gear set (70) for introducing a torque into the first and second planetary gear sets (70, 80).

30. The gearing (10) of claim 28, wherein the first element (71, 81) of each of the first and second planetary gear sets (70, 80) is a sun gear, the second element (72, 82) of each of the first and second planetary gear sets (70, 80) is a planetary carrier, and the third element (73, 83) of each of the first and second planetary gear sets (70, 80) is a ring gear.

31. The gearing (10) of claim 28, wherein each of the third element (73) of the first planetary gear set (70) and the first element (81) of the second planetary gear set (80) is a sun gear, the second element (72, 82) of each of the first and second planetary gear sets (70, 80) is a planetary carrier, and each of the first element (71) of the first planetary gear set (70) and the third element (83) of the second planetary gear set (80) is a ring gear.

32. The gearing (10) of claim 28, wherein the third element (73) of the first planetary gear set (70) is non-rotatably connected to the first element (81) of the second planetary gear set (80).

33. The gearing (10) of claim 28, wherein the first planetary gear set (70) and the second planetary gear set (80) are axially offset from each other, and
wherein tooth engagement of an innermost element (71; 73) of the first, second, and third elements (71, 72, 73) of the first planetary gear set (70) is arranged radially outside tooth engagement of an innermost element (81) of the first, second, and third elements (81, 82, 83) of the second planetary gear set (80).

34. The gearing (10) of claim 28, further comprising:
a stationary member (12), the second element (82) of the second planetary gear set (80) being non-rotatably fixed or non-rotatably fixable to the stationary member (12);
a first output shaft (5), the first output shaft (5) being non-rotatably connected to the second element (72) of the first planetary gear set (70); and
a second output shaft (6), the second output shaft (6) being non-rotatably connected to the third element (83) of the second planetary gear set (80).

35. The gearing (10) of claim 34, wherein the first output shaft (5) and at least part of the second element (72) of the first planetary gear set (70) are formed monolithically.

36. The gearing (10) of claim 34, wherein the third element (73) of the first planetary gear set (70) is non-rotatably connected to the first element (81) of the second planetary gear set (80), and
wherein the first and second planetary gear sets (70, 80) are selectively installable with either:
the first element (71, 81) of each of the first and second planetary gear sets (70, 80) being a sun gear, the second element (72, 82) of each of the first and second planetary gear sets (70, 80) being a planetary carrier, and the third element (73, 83) of each of the first and second planetary gear sets (70,

80) being a ring gear; or
each of the third element (73) of the first planetary gear set (70) and the first element (81) of the second planetary gear set (80) being the sun gears, the second element (72, 82) of each of the first and second planetary gear sets (70, 80) being the planetary carrier, and each of the first element (71) of the first planetary gear set (70) and the third element (83) of the second planetary gear set (80) being the ring gears.

37. The gearing (10) of claim 34, further comprising:
a support portion (66) mechanically operatively connected to the cylindrical gear (62); and
a bearing (65) for rotatably supporting the support portion (66) in a housing portion (16) and for absorbing bending moments of the cylindrical gear (62).

38. The gearing (10) of claim 37, further comprising a further bearing (67) for increasing absorption capacity of the bending moments of the cylindrical gear (62).

39. The gearing (10) of claim 38, wherein at least one of the bearing (65) or the further bearing (67) is on an axial side of the cylindrical gear (62) facing away from the first and second planetary gear sets (70, 80).

40. The gearing (10) of claim 37, wherein the first output shaft (5) and the support portion (66) are both supported in the housing portion (16).

41. The gearing (10) of claim 37, further comprising an electric machine (20), the housing portion (16) receiving and supporting the electric machine (20).

42. The gearing (10) of claim 28, further comprising a coupling element (50) for torque transmission between the third element (73) of the first planetary gear set (70) and the first element (81) of the second planetary gear set (80), the coupling element (50) comprising at least one support element (52; 54) for supporting axial forces on at least one of the first planetary gear set (70) or the second planetary gear set (80).

43. The gearing (10) of claim 28, wherein the cylindrical gear (62) and the one element (71) mechanically operatively connected to the cylindrical gear (62) each mesh via helical toothing with a respective further element (64, 75), and
wherein axial forces of the helical toothings at least partially compensate for each other.

44. The gearing (10) of claim 43, wherein helical directions of the helical toothings effect a lubricant conveying action in the helical toothings for promoting a lubricant discharge for reducing drag torques.

45. The gearing (10) of claim 28, wherein the third element (73) of the first planetary gear set (70) and the first element (81) of the second planetary gear set (80) each mesh via helical toothing with a respective further element (75, 85), and
wherein axial forces of the helical toothings at least partially compensate for each other.

46. The gearing (10) of claim 28, wherein a sun gear is the first element (81), the second element, or the third element of one of the first planetary gear set or the second planetary gear set (80), the sun gear comprising an inner circumferential surface (87) for guiding lubricant towards the other planetary gear set (70) of the one of the first planetary gear set or the second planetary gear set (80).

47. The gearing (10) of claim 28, further comprising a carrier plate (78; 50),
wherein a ring gear is the first element (81), the second element, or the third element of the first planetary gear set (70), the ring gear being coupled to the cylindrical gear (62) or to the first element (81) of the second planetary gear set (80) via the carrier plate (78; 50) for torque transmission.

48. A drivetrain (40), comprising:
the gearing (10) of claim 28; and
a drive apparatus (7) for providing the drive torque.

49. The drivetrain (40) of claim 48, wherein the drive apparatus (7) is axially parallel and spaced apart from the first and second planetary gear sets (70, 80), and from a first output shaft (5) and a second output shaft (6) of the gearing (10), and
wherein the drive apparatus (7) is mechanically operatively connected to the one element (71, 72, 73) via the cylindrical gear (62).

50. The drivetrain (40) of claim 48, wherein the drive apparatus (7) comprises an electric machine (20) with a rotor (22) and a stator (26),
wherein the stator (26) and the rotor (22) do not overlap the first and second planetary gear sets (70, 80) in the axial direction (90).

51. The drivetrain (40) of claim 48, wherein the first planetary gear set (70) is between the second planetary gear set (80) and the drive apparatus (7) in the axial direction (90).

52. The drivetrain (40) of claim 48, wherein the cylindrical gear (62) is between the first planetary gear set (70) and the drive apparatus (7) in the axial direction (90).

53. The drivetrain (40) of claim 48, wherein the drive apparatus (7) further comprises a rotor shaft (24), and
wherein the gearing (10) further comprises a further cylindrical gear (64), the further cylindrical gear (64) being non-rotatably connected to the rotor shaft (24) of the drive apparatus (7) via a spline (25).

54. A vehicle (1), comprising:
the gearing (10) of claim 28.
